(19) United States
(12) Patent Application Publication
(10) Pub. No.: US 2015/0126130 A1
(43) Pub. Date: May 7, 2015

(54) METHOD FOR IMPLEMENTING MDT CONTINUITY

(71) Applicant: Samsung Electronics Co., Ltd., Gyeonggi-do (KR)

(72) Inventors: Wang Hong, Beijing (CN); Lixiang Xu, Beijing (CN)

(21) Appl. No.: 14/410,044

(22) PCT Filed: Jun. 18, 2013
(86) PCT No.: PCT/KR2013/005343

§ 371 Date: Dec. 19, 2014

(30) Foreign Application Priority Data
Jun. 19, 2012 (CN) 201210208896.3

(51) Int. Cl. H04W 24/10

(52) U.S. Cl. CPC H04W 24/10
USPC 455/67.11

(57) ABSTRACT

The present invention provides a method for implementing MDT continuity, for the management based MDT, if the selected PLMN of the UE is the HPLMN of the UE, the EHPLMN of the UE, or the equivalent PLMN of the HPLMN or EHPLMN, the base station obtains the user consent information of the UE, and selects the UE to perform MDT measurement according to the user consent information of the UE; for the signaling based MDT, if the selected PLMN of the UE is the HPLMN of the UE, the EHPLMN of the UE, or the equivalent PLMN of the HPLMN or EHPLMN, the base station obtains the MDT configuration information of the MDT, and performs the MDT measurement according to the MDT configuration information. By using the methods of the present invention, the eNB can select the UE in the scope of the HPLMN of the UE, the EHPLMN of the UE, or the equivalent PLMN of the HPLMN or EHPLMN to perform the MDT measurement and receive the MDT report of the UE, thereby supporting the MDT measurement in the HPLMN, EHPLMN, or the equivalent PLMN of the HPLMN or EHPLMN, and implementing MDT continuity.

### TECHNICAL FIELD

The present invention relates to wireless communication technologies, and more particularly to, a method for implementing MDT continuity.

### BACKGROUND ART

FIG. 1 is a schematic diagram illustrating the structure of a conventional System Architecture Evolution (SAE).

In FIG. 1, a User Equipment (UE) 101 is a terminal device for receiving data. An Evolved Universal Terrestrial Radio Access Network (E-UTRAN) 102 is a radio access network which includes an eNodeB/NodeB for providing a radio network interface for the UE. A Mobile Management Entity (MME) 103 is adapted to manage mobility contexts, session contexts and security information of the UE. A Serving Gateway (SGW) 104 is adapted to provide functions of a subscriber plane. The MME 103 and the SGW 104 may be in the same geography entity. A Packet Gateway (PGW) 105 is adapted to implement charging and legal monitoring functions. The PGW 105 and the SGW 104 may be in the same geography entity. A Policy and Charging Rules Function (PCRF) 106 is adapted to provide QoS policies and charging rules. A Service GPRS Supporting Node (SGSN) 108 is a network node device for providing routing for data transmission in a Universal Mobile Telecommunications System (UMTS). A Home Subscriber Server (HSS) 109 is a home sub-system of the UE and is adapted to protect user information including the current location of the UE, the address of a serving node, user security information and packet data contexts of the UE.

Minimization of drive tests (MDT) is to transmit some measurement information in a control plane to reduce burden of manual tests. The MDT measurement needs to support real-time measurement and non-real-time measurement. Configuration information of the measurement is configured by a network management system in an access network control system (E-UTRAN or UTRAN), and then sent by the access network control system to a UE via a Radio Resource Control (RRC) message. And then MDT measurement results of the UE are sent to the E-UTRAN/UTRAN, the measurement report may include location information and time information. The E-UTRAN/UTRAN sends the measurement result to a MDT entity in a core network.

Based on modes of initiating the MDT, the MDT may be divided into management based MDT and signaling based MDT. The management based MDT refers to that the E-UTRAN/UTRAN receives information of MDT activation from a management entity, and the signaling based MDT refers to that the E-UTRAN/UTRAN receives information of MDT activation from the MME.

FIG. 2 is a schematic diagram illustrating the structure of conventional management based MDT MDT measurement. In FIG. 2,

201 is Element Management (EM), the EM 201 sends a trace activation request to a Network Element (NE) 202, the NE 202 may be an eNB in the LTE system, and the trace activation request includes the configuration information of the MDT. The configuration information of the MDT mainly includes MDT location selection condition, report mechanism configuration, Trace Reference (TR), an IP address of a Trace Collection Entity (TCE), a work type, MDT data anonymity and etc.

The work type may be configured as one of four types: Immediate MDT only Logged MDT only Trace only and Immediate MDT and Trace.

The type of Immediate MDT only is an instant MDT type and refers to that the UE needs to perform the MDT measurement in a connection mode. The type of Logged MDT only is a blog type MDT and refers to that the UE obtains the MDT configuration in the connection mode, the MDT measurement is performed when the UE is in an idle mode, and the MDT measurement result is reported when the UE returns back to the connection mode. For the Trace only type, only trace is performed and the Trace only type is a type not belonging to the MDT. The type of Immediate MDT and Trace refers to that both the instant MDT measurement and the trace measurement are to be performed.

In the MDT location selection condition, the locations of the UE which can be selected to be a user of the MDT measurement are configured. The location selection condition may be configured as a scope of cells, or a scope of a Tracking Area Code (TAC), or a whole PLMN. The UE in the scope can be selected as the UE of the MDT. The TR uniquely identifies a MDT procedure. In the MDT procedure, the eNB may select multiple users to perform the MDT measurement.

The NE 202 selects the UE to perform the MDT measurement. When selecting the UE, the eNB needs to consider user consent information sent by the MME and the location selection condition in the MDT configuration information. If the UE does not consent to perform the MDT or the UE does not meet the location selection condition, the UE can not be selected as the UE of the MDT. After the UE is selected, the eNB assigns Trace Recoding Session Reference (TRSR) for the UE, and sends the MDT configuration information to the UE. The configuration information includes the location selection condition, the report mechanism configuration, TR, TRSR, the identity of the IP address of the TCE.

The UE 203 performs the MDT measurement according to the configuration, and reports the measurement result to the eNB via the MDT report when a report condition is met; the eNB needs to send a Cell Traffic Trace message to the MME after receiving the MDT report from the UE.

The eNB obtains the TR, TRSR, the identity of the IP address of the TCE and the measurement result from the MDT report sent by the UE, finds out the IP address of the TCE according to the identity of the IP address of the TCE, and the relation between the identity and the IP address is pre-stored in the eNB, and then the eNB sends the Cell Traffic Trace message to the MME. The message includes the TR, TRSR, a cell identity, S1 AP Id assigned for the UE by the eNB and MME, and the IP address of the TCE.

After receiving the Cell Traffic Trace message, the MME finds IMSI or IMEISV of the UE, and sends the IMSI/IMEISV to the TCE.

The NE 202 stores a MDT record, and finds the IP address of the TCE according to a preset strategy and the identity of the IP address of the TCE sent by the UE. The relation between the identity of the IP address of the TCE and the IP address of the TCE is pre-stored in the eNB. The eNB sends the MDT record to the TCE, and the TCE realizes the UE corresponding to the MDT record according to the information sent by the MME and the eNB.

The work types supported by the signaling based MDT also include the above four types, and in the signaling based MDT, the MDT start message is sent to the eNB by the MME, the configuration information is sent to the eNB by the MME, and the TR and the TRSR are assigned by the MME. When the UE moves between different eNBs, the MDT configuration information needs to be transmitted to the target eNB. The MDT configuration information of the management based MDT does not need to be transmitted to the target eNB.

Currently, only the MDT measurement and report performed in the same Public Land Mobile Network (PLMN) are supported.

It is supported that the UE receives the configuration information of the MDT measurement from the network side when the UE is located at a cell of the a PLMN, when the UE moves to a cell of another PLMN, the UE will find that the PLMN identity of the selected cell and the PLMN identity of the cell configured with the MDT measurement are different. In this way, the UE will not perform the MDT measurement, and will not report the measurement result to the network side. As can be seen, the UE only supports the MDT measurement in one PLMN.

Similarly, the network side only supports the MDT measurement in one PLMN. For the signaling based MDT, the source eNB sends the configuration information of the MDT to the target eNB only when the identities of the source PLMN and the target PLMN are the same. For the management based MDT, when the UE performs the X2 handover, the source eNB sends the user consent information to the target eNB only when the identities of the source PLMN and the target PLMN are the same. When the target eNB belongs to another PLMN, the target eNB can not select the UE to perform the MDT measurement or keep performing the MDT measurement without the user consent information or configuration information of the MDT.

### DISCLOSURE OF INVENTION

### Technical Problem

One operator may have multiple PLMN identities, the requirement of practical applications includes: the MDT measurement of the UE needs being continuous in the scope of one operator, that is, when the UE moves to another PLMN, if the PLMN and the original PLMN belong to the same operator, the MDT measurement can be performed continuously, and reported to the network continuously. However, the current mechanism can not satisfy this requirement.

### Solution to Problem

The embodiments of the present invention provide a method for implementing MDT continuity to implement MDT continuity in different PLMNs.

The embodiments of the present invention provide a method for implementing MDT continuity, and the method comprises:

A. if selected Public Land Mobile Network (PLMN) of a UE is a Home PLMN (HPLMN) of the UE, or an Equivalent home PLMN (EHPLMN) of the UE, or an equivalent PLMN of the HPLMN or EHPLMN of the UE, or belongs to a MDT PLMN list, obtaining, by a base station, user consent information of the UE; the MDT PLMN list indicating a scope of PLMNs supporting the MDT measurement continuity;

B. selecting, by the base station, the UE to perform MDT measurement according to the user consent information of the UE.

Preferably, the base station of step A is a target base station;

and step A comprises:

in a S1 handover procedure, obtaining, by the target base station, the user consent information of the UE from a handover request message sent by a Mobile Management Entity (MME);

or in a X2 handover procedure, sending, by the target base station, a path handover request message to the MME, the path handover request message comprising an identity of the selected PLMN of the UE, and obtaining the user consent information of the UE from a path handover request response message sent by the MME;

or in an X2 handover procedure, obtaining, by the target base station, the user consent information of the UE from a handover request message sent by a source base station.

Preferably, the base station of step A is a base station in a Radio Resource Control (RRC) setup procedure;

the step A comprises: in the RRC setup procedure, obtaining, by the base station, the user consent information of the UE from an initial context setup message sent by the MME.

Preferably, the base station of step A is a target base station after a handover procedure;

the step A comprises: obtaining, by the target base station, the user consent information of the UE from a downlink non-access layer transmission message or an initial context modify request message sent by the MME.

Preferably, the step A further comprises: obtaining, by the base station, MDT configuration information of the MDT and/or HPLMN identity and/or EHPLMN identity of the UE.

Preferably, the EHPLMN identity of the UE is sent to the MME by a Home Subscriber Server (HSS) of the UE via a location update acknowledgement message when the UE initiates a register procedure.

Preferably, the path handover request message sent to the MME by the target base station includes an indication indicating that the target base station needs to obtain the MDT PLMN list;

the path handover request response message sent by the MME includes the MDT PLMN list.

The embodiments of the present invention provide a method for implementing MDT continuity, applied by a signaling based MDT, and the method comprises:

A. if selected Public Land Mobile Network (PLMN) of a UE is a Home PLMN (HPLMN) of the UE, or an Equivalent home PLMN (EHPLMN) of the UE, or an equivalent PLMN of the HPLMN or EHPLMN of the UE, or belongs to a MDT PLMN list, obtaining, by a base station, MDT configuration information of the MDT; the MDT PLMN list indicating a scope of PLMNs supporting the MDT measurement continuity;

B. performing, by the base station, MDT measurement according to the MDT configuration information.

Preferably, the base station of step A is a target base station in a handover procedure;

and step A comprises:

in a S1 handover procedure, obtaining, by the target base station, the MDT configuration information from a handover request message sent by a Mobile Management Entity (MME);

or in a X2 handover procedure, sending, by the target base station, a path handover request message to the MME, the path handover request message comprising an identity of the selected PLMN of the UE, and obtaining, the MDT configuration information from a path handover request response message sent by the MME;

or in an X2 handover procedure, obtaining, by the target base station, the MDT configuration information from a handover request message sent by the source base station.

Preferably, the base station of step A is a target base station after a handover procedure;

the step A comprises: obtaining, by the target base station, the MDT configuration information from a downlink non-access layer transmission message or an initial context modify request message sent by the MME.

Preferably, the step A further comprises: obtaining, by the base station, user consent information of the UE and/or HPLMN identity and/or EHPLMN identity of the UE.

Preferably, the EHPLMN identity of the UE is sent to the MME by a Home Subscriber Server (HSS) of the UE via a location update acknowledgement message when the UE initiates a register procedure.

Preferably, the path handover request message sent to the MME by the target base station includes an indication indicating that the target base station needs to obtain the MDT PLMN list;

the path handover request response message sent by the MME includes the MDT PLMN list.

### Advantageous Effects of Invention

As can be seen, in the methods for implementing MDT continuity provided by the embodiments of the present invention, for the management based MDT, if the selected PLMN of the UE is the HPLMN of the UE, the EHPLMN of the UE, or the equivalent PLMN of the HPLMN or EHPLMN, the base station obtains the user consent information of the UE, and selects the UE to perform the MDT measurement according to the obtained user consent information; for the signaling based MDT, if the selected PLMN of the UE is the HPLMN of the UE, the EHPLMN of the UE, or the equivalent PLMN of the HPLMN or EHPLMN, the base station obtains the MDT configuration information of the MDT, and performs the MDT measurement according to the MDT configuration information. By using the methods of the present invention, the eNB may select the UE in the scope of the HPLMN of the UE, the EHPLMN of the UE, or the equivalent PLMN of the HPLMN or EHPLMN to perform the MDT measurement and receive the MDT report of the UE, thereby supporting the MDT measurement in the HPLMN, EHPLMN, or the equivalent PLMN of the HPLMN or EHPLMN, and implementing MDT continuity.

### BRIEF DESCRIPTION OF DRAWINGS

FIG. 1 is a schematic diagram illustrating the structure of a conventional SAE system.

FIG. 2 is a schematic diagram illustrating the structure of conventional management based MDT measurement.

FIG. 3 is a flowchart illustrating a method for implementing MDT continuity according to a first embodiment of the present invention.

FIG. 4 is a flowchart illustrating a method for implementing MDT continuity according to a second embodiment of the present invention.

FIG. 5 is a flowchart illustrating a method for implementing MDT continuity according to a third embodiment of the present invention.

FIG. 6 is a flowchart illustrating a method for implementing MDT continuity according to a fourth embodiment of the present invention.

FIG. 7 is a flowchart illustrating a method for implementing MDT continuity according to a fifth embodiment of the present invention.

FIG. 8 is a flowchart illustrating a method for implementing MDT continuity according to a sixth embodiment of the present invention.

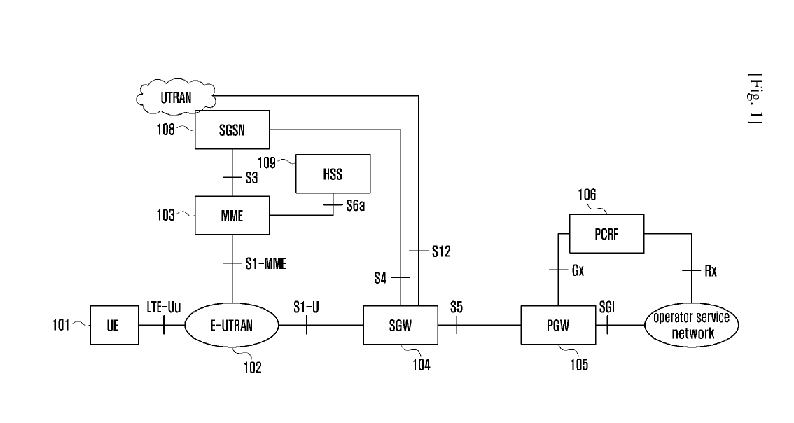

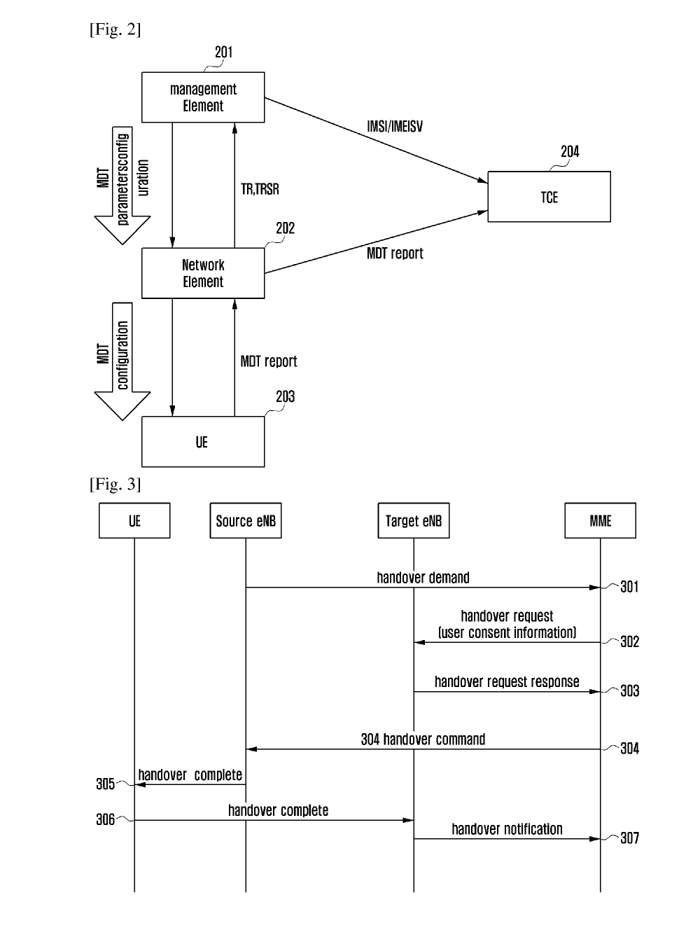

### MODE FOR THE INVENTION

The present invention is hereinafter further described in detail with reference to the accompanying drawings as well as embodiments so as to make the objective, technical solution and merits thereof clearer.

Each PLMN has a PLMN identity, and the PLMN identity includes a Mobile Country Code (MCC) and a Mobile Network Code (MNC).

A Home PLMN (HPLMN) refers to a PLMN the identity of which has the same MCC and MNC with the MCC and MNC in the IMSI of the user respectively. An Equivalent home PLMN (EHPLMN) is a group of PLMNs, the group of the PLMNs is equivalent with the HPLMN of the UE, and the identities of this group of PLMNs constitute an EHPLMN list. The EHPLMN list of the UE is contract information of the UE, stored by the HSS, and sent by the HSS to the MME. When the UE initiates a register procedure, the MME sends a location update request to the HSS to request to obtain the contract information of the UE, and the HSS sends the EHPLMN to the MME via a location update acknowledgement.

In a handover procedure or RRC connection setup procedure, a target PLMN selected for the UE is also called as a register PLMN (rPLMN) or selected PLMN in current protocol.

The network configures an equivalent PLMN list for the selected PLMN. The equivalent PLMN list, called as ePLMN list for short, is characteristic supported in current protocol, and is configured by the MME which sends the equivalent PLMN list to the eNB and the UE. The equivalent PLMN of the HPLMN or EHPLMN mean that: if the HPLMN or EHPLMN is included in the ePLMN list of the selected PLMN, other PLMNs in the ePLMN list of the selected PLMN are all equivalent PLMNs of the HPLMN or EHPLMN.

The main idea of the present invention is to support the MDT measurement continuity in the scope of the HPLMN of the UE, the EHPLMN of the UE, and the equivalent PLMN of the HPLMN or EHPLMN.

For the management based MDT, if the selected PLMN of the UE is the HPLMN of the UE, the EHPLMN of the UE, or the equivalent PLMN of the HPLMN or EHPLMN, the base station obtains the user consent information of the UE, and selects the UE to perform the MDT measurement according to the obtained user consent information. for the signaling based MDT, if the selected PLMN of the UE is the HPLMN of the UE, the EHPLMN of the UE, or the equivalent PLMN of the HPLMN or EHPLMN, the base station obtains the MDT configuration information of the MDT, and performs the MDT measurement according to the obtained MDT configuration information.

Or a PLMN list may be defined singly for the MDT, called as a MDT PLMN list, the list includes identities of a group of the PLMNs and indicates the scope of PLMNs in which the MDT measurement continuity is supported.

Six preferable embodiments will be described in detail as following.

The first embodiment is provided.

In the first embodiment, when the S1 handover is performed, a MME sends the user consent information, MDT configuration information, a HPLMN identity and EHPLMN identity to an eNB. For the management based MDT, at least the user consent information needs to be sent; for the signaling based MDT, at least the MDT configuration information needs to be sent. By using the method, MDT continuity in different PLMNs is implemented. The first embodiment is described based on FIG. 3. The method shown in FIG. 3 includes the following steps.

Step 301: a source eNB sends a handover demand message to a MME. The principle of determining a S1 handover is the same as the current mechanism, and the S1 handover is determined according to a measurement report of the UE and a resource management strategy of the source eNB. The handover demand message includes an identity of a target eNB and a target area identity (TAI) selected by the source eNB for the UE, and the TAI includes an identity of a selected PLMN of the UE.

Step 302: the MME sends a handover request to the target eNB.

If the selected PLMN of the UE in the step 301 is the HPLMN of the UE, the EHPLMN of the UE, or the equivalent PLMN of the HPLMN or EHPLMN, the MME can configure the UE to start the MDT measurement in the target PLMN or keep performing the MDT measurement.

Currently, supported MDT includes a management based MDT and signaling based MDT.

For the management based MDT, if the selected PLMN of the UE is the HPLMN of the UE, the EHPLMN of the UE, or the equivalent PLMN of the HPLMN or EHPLMN, the MME checks the user consent information of the UE, the user consent information indicates whether the user can perform the MDT measurement. If the user can perform the MDT measurement, the MME sends the user consent information (called as management based MDT allowed information in S1 interface) to the target base station via a handover request message; otherwise, the handover request message sent by the MME to the target base station does not includes the “management based MDT allowed” information.

For the signaling based MDT, if the source eNB has started the signaling based MDT, the type of the MDT is Immediate MDT, if the selected PLMN of the UE is the HPLMN of the UE, the EHPLMN of the UE, or the equivalent PLMN of the HPLMN or EHPLMN, the MME sends a handover request message carrying the MDT configuration information of the MDT to the target eNB. The MDT configuration information is the same as the configuration information sent to the source eNB. The target eNB may check whether the target cell is in the scope configured in the MDT configuration information, if the target cell is in the scope configured in the MDT configuration information, the target cell can keep receiving the measurement report sent by the UE; otherwise, the target cell may initiate a MDT terminating procedure and send a trace deactivation message to the MME. Because the target cell of the target eNB can keep receiving the MDT measurement report of the UE, and the MDT can be performed continuously in the target cell.

If the source eNB does not start the signaling based MDT, the MME may initiate a new MDT measurement, and send a handover request message carrying the MDT configuration information of the MDT to the target eNB.

The handover request message sent by the MME may also include the HPLMN identity and/or EHPLMN identity of the UE. By using this information, in the subsequent X2 handover, the eNB can determine whether to send the MDT configuration information and/or the user consent information to the target eNB, which will be described in the third embodiment. The eNB also can determine whether MDT configuration information received from other network entity is legal by using this information. If the PLMN corresponding to the PLMN identity included in the TR of the MDT configuration information is the HPLMN of the UE, the EHPLMN of the UE, or the equivalent PLMN of the HPLMN or EHPLMN, the received MDT configuration information is legal, otherwise, the eNB ignores the MDT configuration information.

Step 303: the target eNB stores the information in the handover request message, and sends a handover request response message to the MME. The handover request response message includes established bearer information, bearer information to be cancelled and transparence transmission container from the source to the target, and the container includes information to be sent to the UE via the source eNB.

Step 304: the MME sends a handover command to the source eNB. The handover command includes the bearer information and the transparence transmission container from the source to the target.

Step 305: the source eNB sends a handover command message to the UE.

Step 306: after completing synchronization with the target cell, the UE sends a handover complete message to the target eNB. The uplink and downlink data may start to be transmitted.

Step 307: the target eNB sends a handover notification to the MME.

The S1 handover procedure is completed.

The second embodiment is provided.

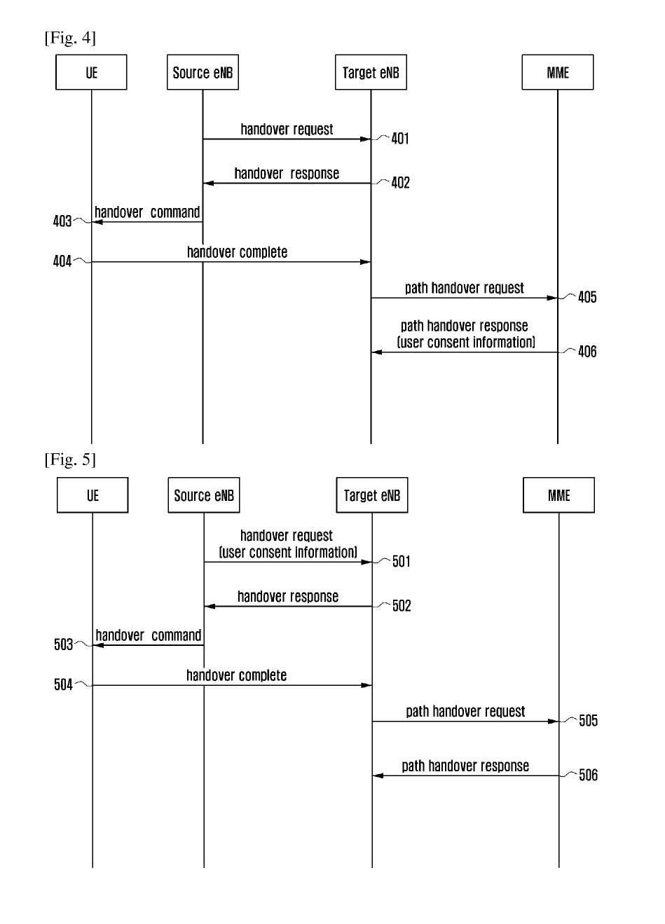

In the second embodiment, the MME sends the user consent information, MDT configuration information, a HPLMN identity and EHPLMN identity to the eNB when the X2 handover is performed. For the management based MDT, at least the user consent information needs to be sent; for the signaling based MDT, at least the MDT configuration information needs to be sent. By using the method, MDT continuity in different PLMNs is implemented. The second embodiment is described based on FIG. 4. The method shown in FIG. 4 includes the following steps.

Step 401: a source eNB sends a handover request message to a target eNB. The handover request message includes an identity of a target cell, an identity of a selected PLMN of the UE, bearer information to be established and etc.

Step 402: the target eNB sends a handover response message to the target eNB. The message includes bearer information that can be established, and transparence transmission container from the source to the target, and the container includes information to be sent to the UE.

Step 403: the source eNB sends a handover command to the UE.

Step 404: after completing synchronization with the target cell, the UE sends a handover complete message to the target eNB. The uplink and downlink data may start to be transmitted.

Step 405: the target eNB sends a path handover request message to the MME. The message includes the TAI, and the TAI includes the identity of the selected PLMN of the UE.

Step 406: the MME sends a path handover request response message to the target eNB.

In this step, the MME determines whether the current target PLMN of the UE is the HPLMN of the UE, the EHPLMN of the UE, or the equivalent PLMN of the HPLMN or EHPLMN, or belongs to the MDT PLMN list.

For the management based MDT, if determining result is yes, the MME checks the user consent information which indicates whether the user can perform the MDT measurement. If the user can perform the MDT measurement, the MME sends the “management based MDT allowed” information to the target base station via the path handover request response message; otherwise, the handover request response message sent by the MME to the target base station does not includes the “management based MDT allowed” information.

For the signaling based MDT, if the source eNB has started the signaling based MDT, the type of the MDT is Immediate MDT, if the selected PLMN of the UE is the HPLMN of the UE, the EHPLMN of the UE, or the equivalent PLMN of the HPLMN or EHPLMN, or belongs to the MDT PLMN list, the MME sends the path handover request response carrying the MDT configuration information of the MDT to the target eNB. The MDT configuration information is the same with the configuration information sent to the source eNB. The target eNB may check whether the target cell is in the scope configured in the MDT configuration information, if the target cell is in the scope configured in the MDT configuration information, the target cell can keep receiving the measurement report sent by the UE, so that the MDT can be performed continuously in the target cell.

The X2 handover procedure is completed.

In the above descriptions, the user consent information and/or MDT configuration information is sent to the eNB during the handover procedures. In detail implementations, the user consent information and/or MDT configuration information may be sent to the eNB after the handover procedures. If the UE switches to an eNB of a different PLMN, after the handover procedure is completed, a TA update procedure needs to be initiated, the UE sends a TA update request message to the MME, after receiving the TA update request message sent by the UE, the MME sends a downlink non-access layer transmission message to the eNB, and the message includes TA update acknowledgement message to be sent to the UE, and the message may also include the user consent information and/or MDT configuration information. Or after the handover procedure is completed, the MME sends an initial context modify request message to the eNB, and the message includes the user consent information and/or MDT configuration information.

The third embodiment is provided.

In the third embodiment, the source eNB sends the user consent information, MDT configuration information, HPLMN identity and EHPLMN identity to the target eNB when the X2 handover is performed. For the management based MDT, at least the user consent information needs to be sent; for the signaling based MDT, at least the MDT configuration information needs to be sent. By using the method, MDT continuity in different PLMNs is implemented. The third embodiment is described based on FIG. 5. The method shown in FIG. 5 includes the following steps.

Step 501: a source eNB sends a handover request message to a target eNB. The handover request message includes an identity of a target cell, an identity of a selected PLMN of the UE, bearer information to be established and etc.

In this step, the source eNB needs to determine whether the selected target PLMN of the UE is the HPLMN of the UE, the EHPLMN of the UE, or the equivalent PLMN of the HPLMN or EHPLMN, which may be performed according to a list of HPLMN, EHPLMN and ePLMN stored in the eNB.

The eNB may obtain the identities of the HPLMN and EHPLMN of the UE from the handover request message sent by the MME through the step 302 in the first embodiment, or the eNB may obtain the identities of the HPLMN and EHPLMN of the UE from the initial context setup request message sent by the MME through the step 703 in the fifth embodiment, or the identities of the HPLMN and EHPLMN of the UE may be transmitted to the source eNB via the X2 handover request message in the X2 handover procedure describe in the embodiment. The ePLMN list is also obtained via the above three messages, and corresponding messages in the current protocol have included the ePLMN list.

For the management based MDT, if the selected PLMN is the HPLMN of the UE, the EHPLMN of the UE, or the equivalent PLMN of the HPLMN or EHPLMN, the source eNB sends the user consent information (called as management based MDT allowed information in X2) to the target base station via the handover request message; otherwise, the handover request message sent by the source eNB to the target base station does not includes the “management based MDT allowed” information.

For the signaling based MDT, if the source eNB has started the signaling based MDT, the type of the MDT is Immediate MDT, if the selected PLMN of the UE is the HPLMN of the UE, the EHPLMN of the UE, or the equivalent PLMN of the HPLMN or EHPLMN, the source eNB needs to send a handover request message carrying the MDT configuration information of the MDT to the target eNB. The target eNB may check whether the target cell is in the scope configured in the MDT configuration information, if the target cell is in the scope configured in the MDT configuration information, the target cell can keep receiving the measurement report sent by the UE, so that the MDT can be performed continuously in the target cell.

The handover request message sent by the source eNB may also include the HPLMN identity and/or EHPLMN identity of the UE. By using this information, in the subsequent X2 handover, the eNB can determine whether to send the MDT configuration information and/or the user consent information to the target eNB.

Step 502: the target eNB sends a handover response message to the source eNB. The handover response message includes bearer information that can be established and transparence transmission container from the source to the target. The container includes the information to be sent to the UE.

Step 503: the source eNB sends a handover command message to the UE.

Step 504: after completing synchronization with the target cell, the UE sends a handover complete message to the target eNB. The uplink and downlink data may start to be transmitted.

Step 505: the target eNB sends a path handover request message to the MME. The message includes the TAI, and the TAI includes the identity of the selected PLMN of the UE.

Step 506: the MME sends a path handover request response message to the target eNB.

The X2 handover procedure is completed.

The fourth embodiment is provided.

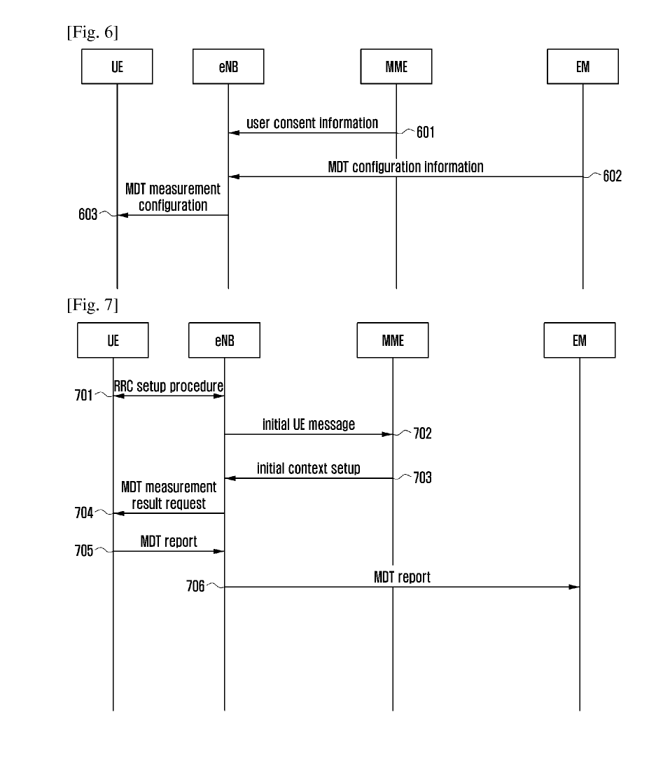

In the fourth embodiment, after the eNB obtains the user consent information by using the methods of the first, second, third or fifth embodiments, how to select the UE to perform the MDT measurement by the eNB is described. By using the method, when the UE moves to a different PLMN, as long as the PLMN is the PLMN of the UE, the EHPLMN of the UE, or the equivalent PLMN of the PLMN or EHPLMN, the UE can be selected to perform the MDT measurement, so that MDT continuity in different PLMNs is implemented. The fourth embodiment is described based on FIG. 6. The method shown in FIG. 6 includes the following steps.

Step 601: the MME sends the user consent information to the eNB.

This step may be step 302 of the first embodiment, or step 406 of the second embodiment, or step 703 of the fifth embodiment, or step 501 of the third embodiment in which the source eNB sends the user consent information to the target eNB.

Step 602: the EM sends the MDT configuration information to the eNB.

The MDT configuration information includes MDT location selection condition, report mechanism configuration, IP addresses of TR and TCE, the work type, MDT data anonymity and etc.

Step 603: the eNB selects the UE to perform the MDT measurement according to area information in the MDT configuration information and user consent information.

As long as the location of the UE meets the requirements of the area information, and the user consent information is configured as consent, the eNB can select the UE to perform the MDT measurement; otherwise, the UE can not be selected to perform the MDT measurement.

The fifth embodiment is provided.

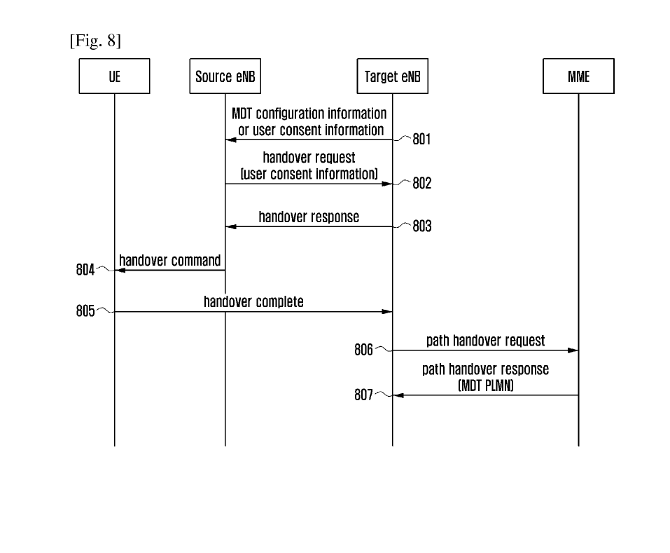

The fifth embodiment describes a method in which the UE reports the MDT report, the eNB stores the MDT report and sends the report to the TCE. By using the method, the MDT continuity in different PLMNs is implemented, and the MDT measurement record can be reported to the eNB. The fifth embodiment is described based on FIG. 7. The method shown in FIG. 7 includes the following steps.

Step 701: in the RRC setup procedure, the UE reports an indication to the eNB to indicate that the user has stored the MDT record. Three messages are included in the RRC setup procedure, which are a RRC request message sent by the UE to the eNB, a RRC setup message sent by the eNB to the UE, and a RRC setup complete message sent by the UE to the eNB. The RRC setup complete message includes a non-access layer message and an identity indicating whether the UE has stored the MDT record.

Step 702: the eNB sends an initial UE message to the MME, the message includes the non-access layer message sent by the UE and the TAI, the TAI includes the identity of the PLMN selected for the UE.

Step 703: the MME determines whether the PLMN selected for the UE is the HPLMN of the UE, the EHPLMN of the UE, or the equivalent PLMN of the HPLMN or EHPLMN, if yes, the MME checks the user consent information of the UE, the user consent information indicates whether the user can perform the MDT measurement. If the user can perform the MDT measurement, the MME sends the user consent information to the eNB via an initial context setup message; otherwise, the initial context setup message does not include the “management based MDT allowed” information.

If the PLMN selected for the UE is the HPLMN of the UE, the EHPLMN of the UE, or the equivalent PLMN of the HPLMN or EHPLMN, the initial context setup message may also include the HPLMN identity and EHPLMN identity. By using the HPLMN identity and EHPLMN identity, the eNB can determine whether to send the MDT configuration information and the user consent information to the target eNB when performing the X2 handover.

Step 704: the eNB stores the information received from the MME, if the UE indicates that the UE has stored the MDT record, and the eNB also stores the user consent information of the UE, the eNB sends a UE information request message to the UE to request the UE to send the MDT record to the eNB. If the eNB does not have the user consent information of the UE, the eNB does not send the UE information request message to the UE. The eNB may also determine whether to request the report of the MDT record from the UE according to the identities of the HPLMN and EHPLMN included in the 703 message. If the selected PLMN of the UE is the HPLMN of the UE, the EHPLMN of the UE, or the equivalent PLMN of the HPLMN or EHPLMN, the eNB sends the UE information request message to the UE to request the UE to send the information report message.

Step 705: the UE sends a MDT report to the eNB. The MDT report includes the TR, TRST, TCE identity and MDT record.

Step 706: the eNB finds out the IP address of the TCE corresponding to the TCE identity according to the TCE identity in the MDT report and PLMN identity included in the TR, and sends the MDT report to the TCE according to a preset report mechanism.

In the above embodiments, the ePLMN list, identities of the HPLMN and the EHPLMN already defined in the current related protocol are used to determine the PLMNs in which the MDT is continuous. Another method provided by the present invention will be described as follows.

In the method, the core network defines the MDT PLMN list and sends the MDT PLMN list to the eNB via the Trace Activation request message or initial context setup request message. In the X2 handover, the source eNB determines whether the identity of the target PLMN is in the list according to the MDT PLMN list, if the target PLMN is in the MDT PLMN list, the MDT configuration information or/and user consent information and MDT PLMN list are transmitted to the eNB; if the target PLMN is not in the MDT PLMN list, the MDT configuration information or/and user consent information and MDT PLMN list are not transmitted to the eNB. The MME may perform the above determination according to the MDT PLMN list and perform corresponding processing according to the determining result, as described in the above embodiments.

When the source eNB and the target eNB support different versions, if the source eNB supports the version 10, the target eNB supports the version 11, the X2 handover request message sent by the eNB supporting the version 10 can not include the MDT PLMN list because the message of the version 10 does not support this characteristic, in this way, the source eNB can not send the MDT PLMN list to the target eNB. If the target eNB supports the version 11, the target eNB can not perform the above determining according to the MDT PLMN list in the subsequent X2 handover, and thus the MDT measurement can not be performed continuously.

The sixth embodiment describes how to make the MDT measurement continuous when the source eNB and the target eNB belong to the same PLMN, but the source eNB supports the version 10, the target eNB supports the version 11. The sixth embodiment is described based on FIG. 8. The method shown in FIG. 8 includes the following steps.

Step 801: the MME sends the MDT configuration information to the eNB, and the MDT configuration information may be sent to the eNB via the trace activation request message, the initial context setup request message or the handover request message.

The MME sends the user consent information of the UE to the eNB, the user consent information may be sent to the eNB together with the MDT configuration information, or via different procedures. The message transmitting the user consent information may include: the initial context setup request message or the handover request message.

When transmitting the user consent information or the MDT configuration information, the MME may also transmit the MDT PLMN list. If the MME knows that the eNB supports the version 10 according to the configuration information, the message does not include the MDT PLMN list, because the eNB supporting the version 10 can not parse the MDT PLMN list correctly.

Step 802: when determining that the UE needs to perform the X2 handover, the source eNB sends a handover request message to a target eNB. The handover request message includes an identity of a target cell, an identity of a selected PLMN of the UE, bearer information to be established and etc.

For the management based MDT, if the target PLMN and the source PLMN are the same, or the selected PLMN is in the MDT PLMN list, the source eNB sends the user consent information (called as management based MDT allowed information in X2) to the target base station via the handover request message; otherwise, the handover request message sent by the source eNB to the target base station does not includes the “management based MDT allowed” information.

For the signaling based MDT, if the source eNB has started the signaling based MDT, the type of the MDT is Immediate MDT, if the selected target PLMN and the source PLMN are the same, or the selected target PLMN is in the MDT PLMN list, the source eNB sends a handover request message carrying the MDT configuration information of the MDT to the target eNB. The target eNB may check whether the target cell is in the scope configured in the MDT configuration information, if the target cell is in the scope configured in the MDT configuration information, the target cell can keep receiving the measurement report sent by the UE, and thus the MDT can be performed continuously in the target cell.

If the source eNB support the version 11 and the selected target PLMN and the source PLMN are the same, or the selected target PLMN is in the MDT PLMN list, the handover request message includes the MDT configuration information and/or the user consent information of the UE, and the MDT PLMN list.

If the source eNB support the version 10 and the selected target PLMN and the source PLMN are the same, the handover request message includes the MDT configuration information and/or the user consent information of the UE.

Step 803: the target eNB sends a handover response message to the source eNB. The message includes bearer information that can be established and transparence transmission container from the source to the target, the container includes information to be sent to the UE.

Step 804: the source eNB sends a handover command message to the UE.

Step 805: after completing synchronization with the target cell, the UE sends a handover complete message to the target eNB. The uplink and downlink data may start to be transmitted.

Step 806: the target eNB sends the path handover request message to the MME. The message includes the TAI, the TAI includes the identity of the selected PLMN of the UE. if the target eNB supports the version 11 and receives the MDT configuration information and/or the user consent information sent by the source eNB without the MDT PLMN list, the path handover request message may also includes an indication of “need MDT PLMN list” to indicate that the MME needs to send the MDT PLMN list to the eNB.

Step 807: the MME sends the path handover request response message to the target eNB. If the message in step 806 includes the indication of “need MDT PLMN list”, the path handover request response message also includes the MDT PLMN list.

Or the MDT PLMN list may be not included in the path handover request response message in step 807, but included in the initial context modify message sent by the MME after the step 807.

As can be seen from the above embodiments, in the method for implementing MDT continuity provided by the present invention, the UE consent information is sent to the eNB belongs to the scope of the HPLMN of the UE, the EHPLMN of the UE, or the equivalent PLMN of the HPLMN or EHPLMN, so that the eNB can select the UE in this scope to perform the MDT measurement. The identities of the HPLMN and EHPLMN are sent to the eNB, so that the UE can move between the eNBs in the HPLMN, EHPLMN, or the equivalent PLMN of the HPLMN or EHPLMN, and the MDT record can be received from the UE, thereby supporting the MDT measurement in the scope of the HPLMN, EHPLMN, or the equivalent PLMN, and implementing MDT continuity.

The foregoing is only preferred embodiments of the present invention. It should be noted that those skilled in the art may make improvement and modification within the principle of the present invention, and the improvement and modification should be covered in the protection scope of the invention.

1. A method for implementing minimization of drive tests (MDT) continuity, applied by a management based MDT, comprising:
if a selected public land mobile network (PLMN) of a user equipment (UE) is a home PLMN (HPLMN) of the UE, an equivalent home PLMN (EHPLMN) of the UE, an equivalent PLMN of the HPLMN or EHPLMN of the UE, or belongs to a MDT PLMN list, obtaining, by a base station, user consent information of the UE, wherein the MDT PLMN list indicates a scope of PLMNs supporting the MDT measurement continuity; and
selecting, by the base station, the UE to perform MDT measurement according to the user consent information of the UE.

2. The method of claim 1, wherein the base station is a target base station, and wherein obtaining the user consent information of the UE comprises:
in an S1 handover procedure, obtaining, by the target base station, the user consent information of the UE from a handover request message sent by a mobile management entity (MME);
in a X2 handover procedure, sending, by the target base station, a path handover request message to the MME, the path handover request message comprising an identity of the selected PLMN of the UE, and obtaining the user consent information of the UE from a path handover request response message sent by the MME; or
in a X2 handover procedure, obtaining, by the target base station, the user consent information of the UE from a handover request message sent by a source base station.

3. The method of claim 1, wherein the base station is a base station in a radio resource control (RRC) setup procedure, and wherein obtaining the user consent information of the UE comprises in the RRC setup procedure, obtaining, by the base station, the user consent information of the UE from an initial context setup message sent by the MME.

4. The method of claim 1, wherein the base station is a target base station after a handover procedure, and wherein obtaining the user consent information of the UE comprises: obtaining, by the target base station, the user consent information of the UE from a downlink non-access layer transmission message or an initial context modify request message sent by the MME.

5. The method of claim 1, wherein obtaining the user consent information of the UE further comprises: obtaining, by the base station, at least one of MDT configuration information of the MDT, HPLMN identity, and EHPLMN identity of the UE.

6. The method of claim 5, wherein the EHPLMN identity of the UE is sent to the MME by a home subscriber server (HSS) of the UE via a location update acknowledgement message when the UE initiates a register procedure.

7. The method of claim 2, wherein the path handover request message sent to the MME by the target base station comprises an indication indicating that the target base station needs to obtain the MDT PLMN list, and wherein the path handover request response message sent by the MME comprises the MDT PLMN list.

8. A method for implementing minimization of drive tests (MDT) continuity, applied by a signaling based MDT, comprising:
if a selected public land mobile network (PLMN) of a user equipment (UE), is a home PLMN (HPLMN) of the UE, an equivalent home PLMN (EHPLMN) of the UE, an equivalent PLMN of the HPLMN or EHPLMN of the UE, or belongs to a MDT PLMN list, obtaining, by a base station, MDT configuration information of the MDT, wherein the MDT PLMN list indicates a scope of PLMNs supporting the MDT measurement continuity; and
performing, by the base station, MDT measurement according to the MDT configuration information.

9. The method of claim 8, wherein the base station of is a target base station in a handover procedure, and wherein obtaining, by a base station, the MDT configuration information of the MDT comprises:
in a S1 handover procedure, obtaining, by the target base station, the MDT configuration information from a handover request message sent by a mobile management entity (MME);
in a X2 handover procedure, sending, by the target base station, a path handover request message to the MME, the path handover request message comprising an identity of the selected PLMN of the UE, and obtaining, the MDT configuration information from a path handover request response message sent by the MME; or
in a X2 handover procedure, obtaining, by the target base station, the MDT configuration information from a handover request message sent by the source base station.

10. The method of claim 8, wherein the base station of is a target base station after a handover procedure, wherein obtaining the user consent information of the UE comprises obtaining, by the target base station, the MDT configuration information from a downlink non-access layer transmission message or an initial context modify request message sent by the MME.

11. The method of claim 8, wherein obtaining, by a base station, the MDT configuration information of the MDT further comprises obtaining, by the base station, at least one of user consent information of the UE, HPLMN identity, and EHPLMN identity of the UE.

12. The method of claim 11, wherein the EHPLMN identity of the UE is sent to the MME by a home subscriber server (HSS) of the UE via a location update acknowledgement message when the UE initiates a register procedure.

13. The method of claim 9, wherein the path handover request message sent to the MME by the target base station comprises an indication indicating that the target base station needs to obtain the MDT PLMN list, and wherein the path handover request response message sent by the MME comprises the MDT PLMN list.

14. The method of claim 9, wherein obtaining, by a base station, the MDT configuration information of the MDT further comprises obtaining, by the base station, user consent information of the UE, an HPLMN identity, and EHPLMN identity of the UE.

15. The method of claim 10, wherein obtaining, by a base station, the MDT configuration information of the MDT further comprises obtaining, by the base station, user consent information of the UE, an HPLMN identity, and EHPLMN identity of the UE.

16. A base station for implementing minimization of drive tests (MDT) continuity, applied by one of a management based MDT or a signaling based MDT, the base station configured to:
obtain user consent information of a user equipment (UE) if:
a selected public land mobile network (PLMN) of the UE is a home PLMN (HPLMN) of the UE, an equivalent home PLMN (EHPLMN) of the UE, an equivalent PLMN of the HPLMN or EHPLMN of the UE, or belongs to a MDT PLMN list, wherein the MDT PLMN list indicates a scope of PLMNs supporting the MDT measurement continuity; and
select the UE to perform MDT measurement according to the user consent information of the UE.

17. The base station of claim 16, wherein the base station is a target base station in a handover procedure, and wherein the base station is configured to obtain the MDT configuration information of the MDT by at least one of:
in a S1 handover procedure, obtaining, by the target base station, the MDT configuration information from a handover request message sent by a mobile management entity (MME);
in a X2 handover procedure, sending, by the target base station, a path handover request message to the MME, the path handover request message comprising an identity of the selected PLMN of the UE, and obtaining, the MDT configuration information from a path handover request response message sent by the MME; or
in a X2 handover procedure, obtaining, by the target base station, the MDT configuration information from a handover request message sent by the source base station.

18. The base station of claim 16, wherein the base station is a target base station after a handover procedure, wherein the base station is configured to obtain the user consent information of the UE by obtaining the MDT configuration information from a downlink non-access layer transmission message or an initial context modify request message sent by the MME.

19. The base station of claim 16, wherein the base station is configured to obtain the MDT configuration information of the MDT by obtaining at least one of user consent information of the UE, HPLMN identity, and EHPLMN identity of the UE.

20. The base station of claim 19, wherein the EHPLMN identity of the UE is sent to the MME by a home subscriber server (HSS) of the UE via a location update acknowledgement message when the UE initiates a register procedure.
